(19) United States
(12) Patent Application Publication
(10) Pub. No.: US 2020/0213763 A1
(43) Pub. Date: Jul. 2, 2020

(54) Sound Generator

(71) Applicant: AAC Technologies Pte. Ltd., Singapore city (SG)

(72) Inventors: Hongjian Hu, Shenzhen (CN); Shuwen Wu, Shenzhen (CN)

(21) Appl. No.: 16/706,826

(22) Filed: Dec. 8, 2019

(30) Foreign Application Priority Data
Dec. 30, 2018 (CN) 201822278289.X

(51) Int. Cl. H04R 9/06; H04R 7/12; H04R 7/18; H04R 9/02

(52) U.S. Cl. CPC H04R 9/06; H04R 7/12; H04R 2400/11; H04R 9/025; H04R 7/18

(57) ABSTRACT

The present invention provides a sound generator including: a frame, a magnetic circuit system with a magnetic gap, and a vibration system fixed at the frame. The vibration system includes a vibrating diaphragm fixed at the frame, a voice coil inserted in the magnetic gap for driving the vibrating diaphragm to vibrate, and an elastic support assembly fixed at the frame and opposite to but spaced from the vibrating diaphragm, the elastic support assembly being fixed at one end of the voice coil far away from the vibrating diaphragm. The elastic support assembly includes an elastic part having a first fixation arm fixed at the frame, a second fixation arm fixed, and an elastic arm connecting the first fixation arm to the second fixation arm, and a bending unit obliquely extending from the elastic arm protruding towards a direction toward the vibrating diaphragm.

### FIELD OF THE PRESENT INVENTION

The present invention relates to the field of electroacoustic transducers, in particular to a sound generator for converting electrical signals into audible sounds.

### DESCRIPTION OF RELATED ART

With the arrival of mobile internet era, the number of intelligent mobile devices is on the increase. While among so many mobile devices, mobile phone is undoubtedly the most common and portable mobile terminal device. The sound generators used for playing sound are largely applied in the currently intelligent mobile devices such as mobile phones.

The sound generator of related art comprises a frame and a vibration system fixed at the frame and a magnetic circuit system with a magnetic gap. The vibration system comprises a vibrating diaphragm fixed at the frame, an elastic support assembly connected with the frame and disposed opposite to but spaced from the vibrating diaphragm, and a voice coil connecting the vibrating diaphragm to the elastic support assembly. The voice coil protrudes into the magnetic gap to drive the vibrating diaphragm to vibrate and generate sound. The elastic support assembly comprise an elastic part and an auxiliary vibrating diaphragm connected with the elastic part. The elastic part further comprises a first fixation arm fixed at the frame, a second fixation arm connected with the voice coil, and an elastic arm extending from the first fixation arm to the second fixation arm.

However, in related art, the elastic part has a flat structure, i.e., the first fixation arm, the second fixation arm and the elastic arm are provided in a same plane, so an extension length of the elastic arm is limited, resulting in weak anti-fatigue and -fracture ability of the elastic part, thus the sound generator has a low reliability. Meanwhile, during the vibration of the vibration system, the elastic arm and the auxiliary vibrating diaphragm are susceptible to interference, causing negative influence on the acoustic performance of the sound generator.

Therefore, it is absolutely necessary to provide an improved sound generator to solve the problems above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present invention.

FIG. 1 is an isometric view of a sound generator in accordance with an exemplary embodiment of the present invention.

FIG. 2 is an isometric and exploded view of the sound generator in FIG. 1.

FIG. 3 is a cross-sectional view of the sound generator, taken along line A-A in FIG. 1.

FIG. 4 is an exploded view of an elastic support assembly used in the sound generator.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of the present invention more apparent, the present invention is described in further detail together with the figure and the embodiment. It should be understood the specific embodiment described hereby is only to explain the invention, not intended to limit the invention.

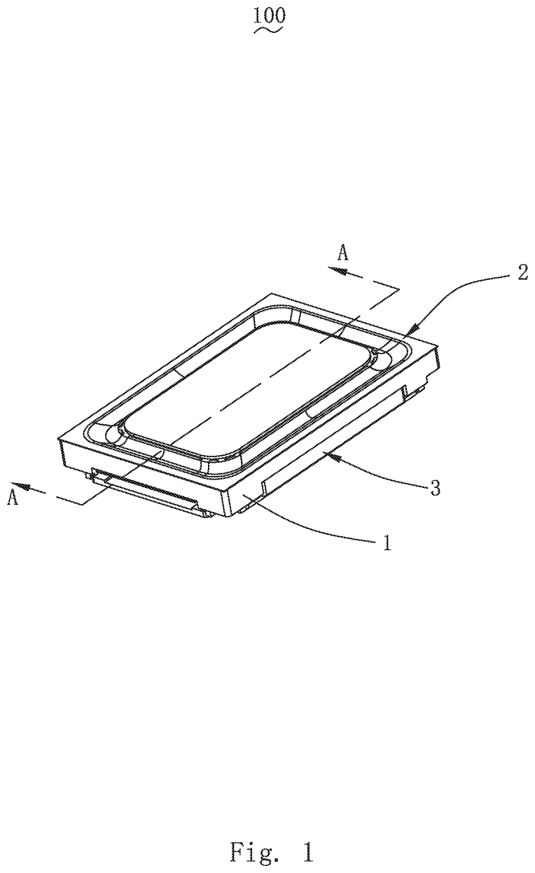

Referring to FIG. 1, the present invention provides a sound generator 100 which comprises a frame 1, a vibration system 2 and a magnetic circuit system 3. The frame 1 is used to support and carry the vibration system 2 and the magnetic circuit system 3.

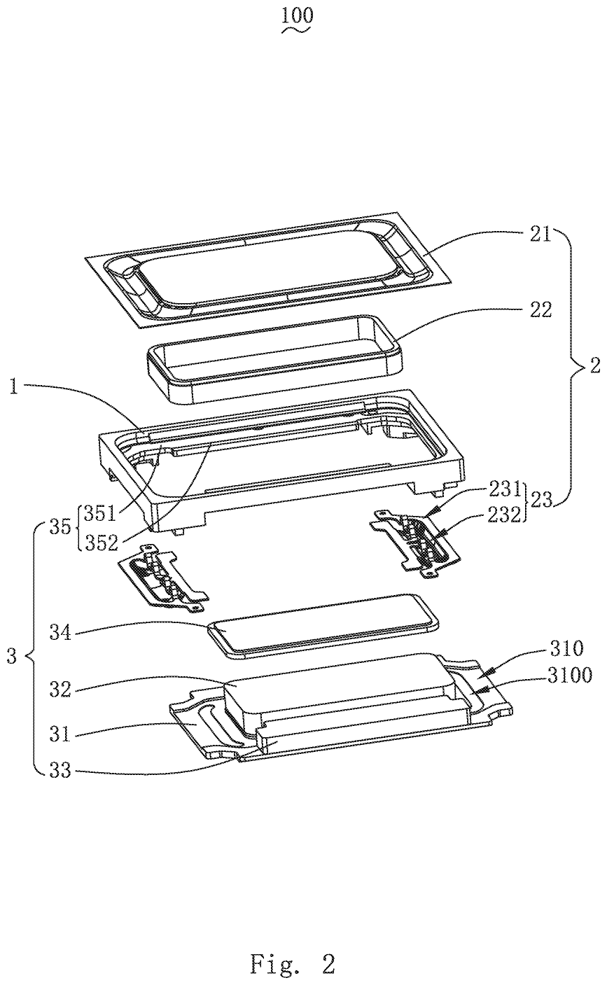

With reference to FIG. 2, the vibration system 2 comprises a vibrating diaphragm 21 fixed at the frame 1, a voice coil 22 and an elastic support assembly 23 fixed at the frame 1 for being opposite to and spaced from the vibrating diaphragm 21. The elastic support assembly 23 is fixed at one end of the voice coil 22 far away from the vibrating diaphragm 21. As shown in FIG. 2, the vibrating diaphragm 21 comprises a middle dome and a suspension ring extending from an edge of the dome. The suspension ring is an arc structure protruding in a direction towards the magnetic circuit system in this embodiment, and it can also be an arc structure protruding in a direction far away from the magnetic circuit system, in other optional embodiments of the present invention.

The magnetic circuit system 3 has a magnetic gap 30. The voice coil 22 includes an end protruding into the magnetic gap 30 for driving the vibrating diaphragm 21 to vibrate and generate sound.

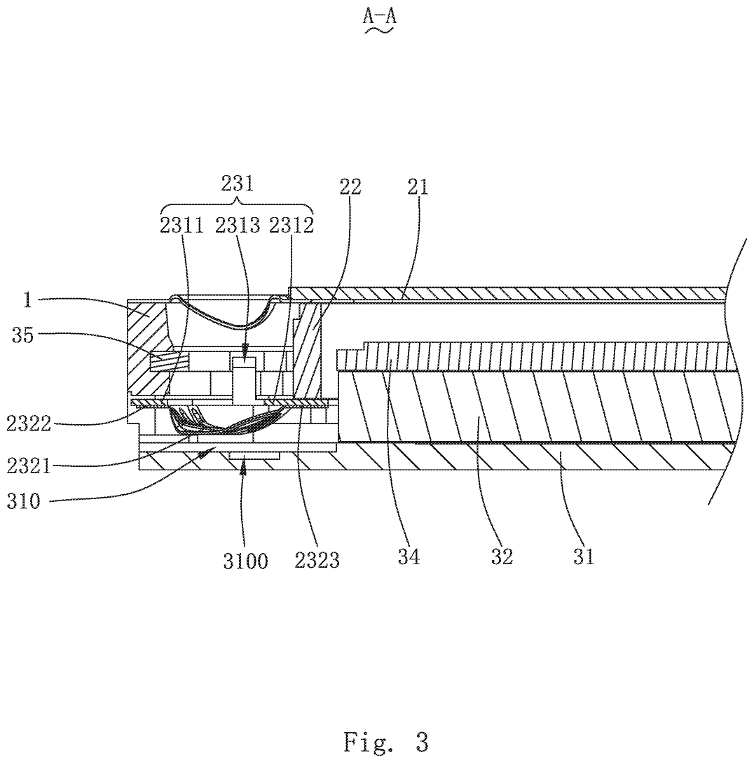

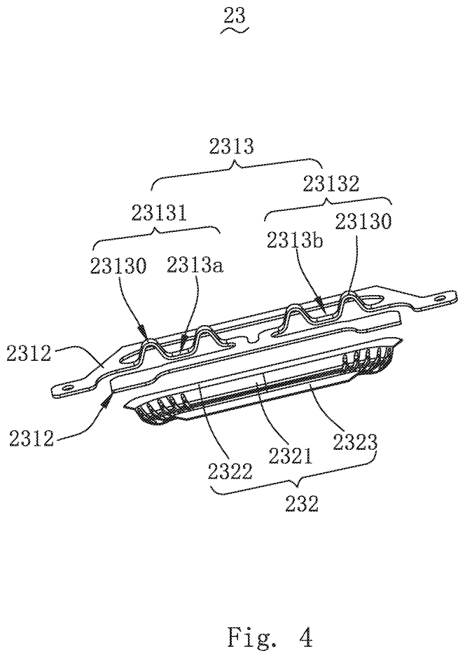

With reference to FIGS. 3-4, in this embodiment, the elastic support assembly 23 comprise an elastic part 231 and an auxiliary vibrating diaphragm 232 fixed at the end of the elastic part 231 far away from the frame 1.

Specifically, the elastic part 231 comprises a first fixation arm 2311 fixed at the frame, a second fixation arm 2312 fixed at the end of the voice coil 22 far away from the vibrating diaphragm 21, an elastic arm 2313 connecting the first fixation arm 2311 to the second arm 2312, and a bending unit 23130 extending obliquely from the elastic arm 2313 along a direction toward the vibrating diaphragm 21.

Further, an amount of the bending unit 23130 is more than one so that the more than one bending units 23130 are arranged spaced from each other. The bending unit 23130 has a shape of an arc piece. Needless to say, the bending shape s of the bending unit 23130 is not limited to such a shape described herein.

In addition, the elastic arm 2313 comprises a first force arm 23131 extending from one end of the first fixation arm 2311 to a middle of the second fixation arm 2312, and a second force arm 23132 extending from the opposite end of the first fixation arm 2311 to the middle of the second fixation arm 2312. Each of the first force arm 23131 and the second force arm 23132 respectively comprises a body part (2313a, 2313b) in a flat plate shape, and the bending unit 23130 bending from the body part and protruding towards the vibrating diaphragm 21.

The auxiliary vibrating diaphragm 232 comprises a suspension ring 2321 in an arc shape protruding towards a direction far away from the vibrating diaphragm 21, a first connecting portion 2322 and a second connecting portion 2323 extending from the two opposite sides of the suspension ring 2321. The first connecting portion 2322 is fixed with one side of the first fixation arm 2311 far away from the vibrating diaphragm 21, the second connecting portion 2323 is fixed with one side of the second fixation arm 2312 far away from the vibrating diaphragm 21. The suspension ring 2321 and the elastic arm 2313 are provided opposite to each other such that the bending direction of the bending unit 23130 is reverse to the bending direction of the suspension ring 2321, thereby better avoiding interference between the bending unit 23130 and the suspension ring 2321.

In the above-described structure, the bending unit 23130 is provided to increase the length of the elastic arm 2313, achieving the improvement of anti-fatigue and -fracture ability of the elastic part 231, bringing a long service life of the elastic support assemblies 23 and in turn a higher reliability of the sound generator 100. Further, the bending unit 23130 protrudes and bends towards the direction close to the vibrating diaphragm 21, thus avoiding the bending unit 23130 to interfere with the auxiliary vibrating diaphragm 232 during vibration and produce bad noise, so as to ensure super acoustic performance of the sound generator 100.

With reference to FIGS. 2-3, in this embodiment, the elastic support assembly 23 comprise two pieces located at the two opposite sides of the voice coil 22. Specifically, taking the voice coil 22 as an example, the two elastic support assemblies 23 are located at both sides of a short axis of the voice coil 22 respectively. The two pieces of elastic support assemblies 23 are provided in a symmetrical configuration, producing a more stable effect of supporting the voice coil 22, better preventing horizontal swing of the voice coil 22, thus producing a good vibration performance of the vibration system 2, so as to improve the acoustic performance of the sound generator 100.

Of course, the quantity and location of the elastic support assemblies 23 are not limited to what is described above; for example, the two elastic support assemblies 23 can be provided on both sides of a long axis of the voice coil 22. In another example, the amount of the elastic support assemblies 23 is four, and the four elastic support assemblies are disposed around the voice coil 22.

It should be noted that, the elastic part 231 is a flexible circuit board, and the voice coil 22 is electrically connected with the elastic part 231, thus on one hand, the voice coil 22 is provided with a support, on another hand, an external electrical signal is introduced to the voice coil 22, thereby avoiding the problem of susceptibility to disconnection when introducing the external electrical signal for the voice coil 22 through a lead, so as to improve its reliability.

With reference to FIGS. 2 and 3, the magnetic circuit system 3 comprises a magnetic yoke 31, a main magnet 32 fixed at the magnetic yoke 31, two auxiliary magnets 33 provided at the two opposite sides of the main magnet 32 for forming the magnetic gap 30 with the main magnet 32.

In this embodiment, the magnetic circuit system 3 is a magnetic circuit of three magnets. Taking the voice coil 22 in a rectangular shape as an example, the two auxiliary magnets 33 are located on the two sides of the long axis of the voice coil 22. The two elastic support assemblies 23 are located on both sides of the short axis of the voice coil 22. Therefore, the structure of magnetic circuit of three magnets brings good driving performance of the magnetic circuit system 3, thus bringing good acoustic performance of the sound generator 100.

Sure, the magnetic circuit structure of the magnetic circuit system 3 is not limited to a magnetic circuit of three magnets. In actual applications, it further allows to optimize the magnetic circuit system 3 to be a magnetic circuit of five magnets according to the demand for optimized design.

To further improve the performance of the magnetic circuit system 3, allowing the magnetic lines of force of the magnetic circuit system 3 to be cut by the voice coil 22 as much as possible to generate greater driving force, the magnetic circuit system 3 further comprises a main pole plate 34 and a clamping plate 35 covering the main magnet. The clamping plate 35 comprises a fixed ring 351 in an annular shape fixed at the frame 1 and two auxiliary pole plates 352 extending towards the auxiliary magnet 33 from the fixed ring 351. The two auxiliary pole plates 352 are provided overlapped on the auxiliary magnet 33. By providing the main pole plate 34 and the auxiliary pole plate 352, the magnetic circuit system 3 has a more concentrated magnetic lines, thus bringing better magnetic performance of the magnetic circuit system 3, so as to further improve the acoustic performance of the sound generator 100.

Compared with related art, the elastic part comprises a first fixation arm fixed at the frame, a second fixation arm fixed at the end of the voice coil 22 far away from the vibrating diaphragm, and an elastic arm connected with the first fixation arm and the second fixation arm. The elastic arm is bent to from a bending unit protruding in a direction close to the vibrating diaphragm. In the above-mentioned structure, the bending unit is provided to increase the length of the elastic arm, to achieve the improvement of anti-fatigue and -fracture ability of the elastic part, and to bring a long service life of the elastic support assemblies and in turn a higher reliability of the sound generator. Further, the bending unit protrudes and bends towards the direction close to the vibrating diaphragm 21, thus avoiding the bending unit to interfere with the auxiliary vibrating diaphragm during vibration, so as to ensure super acoustic performance of the sound generator.

It is to be understood, however, that even though numerous characteristics and advantages of the present exemplary embodiments have been set forth in the foregoing description, together with details of the structures and functions of the embodiments, the invention is illustrative only, and changes may be made in detail, especially in matters of shape, size, and arrangement of parts within the principles of the invention to the full extent indicated by the broad general meaning of the terms where the appended claims are expressed.

What is claimed is:

1. A sound generator comprising:
a frame;
a magnetic circuit system with a magnetic gap;
a vibration system fixed at the frame, including a vibrating diaphragm fixed at the frame, a voice coil inserted in the magnetic gap for driving the vibrating diaphragm to vibrate, and an elastic support assembly fixed at the frame and opposite to but spaced from the vibrating diaphragm, the elastic support assembly being fixed at one end of the voice coil far away from the vibrating diaphragm; wherein
the elastic support assembly comprise an elastic part having a first fixation arm fixed at the frame, a second fixation arm fixed at one end of the voice coil far away from the vibrating diaphragm, and an elastic arm connecting the first fixation arm to the second fixation arm, and a bending unit obliquely extending from the elastic arm protruding towards a direction toward the vibrating diaphragm.

2. The sound generator as described in claim 1, wherein the bending unit comprises a plurality of pieces spaced from each other, and the bending unit has an arc shape.

3. The sound generator as described in claim 2, wherein the elastic support assembly further comprises an auxiliary vibrating diaphragm fixed at one side of the elastic part far away from the vibrating diaphragm; the auxiliary vibrating diaphragm comprises a suspension ring in an arc shape protruding a direction far away from the vibrating diaphragm, and a first connecting portion and a second connecting portion extending from the two opposite sides of the suspension ring respectively; the first connecting portion is fixed with one side of the first fixation arm far away from the vibrating diaphragm, the second connecting portion is fixed with one side of the second fixation arm far away from the vibrating diaphragm, the suspension ring and the elastic arm are provided opposite to each other.

4. The sound generator as described in claim 1, wherein the elastic support assembly comprise two pieces which are located on the two opposite sides of the voice coil.

5. The sound generator as described in claim 4, wherein the voice coil has a rectangular shape, and the two elastic support assemblies are located on the two sides of a short axis of the voice coil respectively.

6. The sound generator as described in claim 3, wherein the magnetic circuit system comprises a magnetic yoke, a main magnet fixed at the magnetic yoke and two auxiliary magnets provided spaced apart on the two opposite sides of the main magnet for forming the magnetic gap with the main magnet, the two auxiliary magnets are located on the two sides of a long axis of the voice coil.

7. The sound generator as described in claim 6, wherein the magnetic circuit system further comprises a main pole plate covering the main magnet and a clamping plate fixed at the frame, the clamping plate comprises a fixed ring in an annular shape fixed at the frame and two auxiliary pole plates extending form the fixed ring towards the auxiliary magnet, the two auxiliary pole plates are provided overlapped on the auxiliary magnets respectively.

8. The sound generator as described in claim 1, wherein the elastic part is a flexible circuit board electrically connected with the voice coil.

9. The sound generator as described in claim 6, wherein one side of the magnetic yoke close to the auxiliary vibrating diaphragm is concave towards the direction far away from the auxiliary vibrating diaphragm for forming an anti-collision groove, the anti-collision groove is corresponding to the auxiliary vibrating diaphragm.

10. The sound generator as described in claim 9, wherein the anti-collision groove is further partly concave towards the direction far away from the auxiliary vibrating diaphragm for forming a concave part which is corresponding to a position where an amplitude of the auxiliary vibrating diaphragm is.

11. The sound generator as described in claim 1, wherein the elastic arm comprises a first force arm extending from one end of the first fixation arm to a middle of the second fixation arm, and a second force arm extending from another end of the first fixation arm to the middle of the second fixation arm; each of the first force arm and the second force arm comprises a body part in a flat plate shape and a bending unit bending from the body parts and protruding towards the vibrating diaphragm.
